(19) United States
(12) Patent Application Publication
(10) Pub. No.: US 2010/0062848 A1
(43) Pub. Date: Mar. 11, 2010

(54) Vehicle entertainment system operable by a remote device and method for remotely operating a vehicle entertainment system

(75) Inventors: Joseph Ballay, Pittsburgh, PA (US); Michael McManus, Oakdale, PA (US)

Correspondence Address: PANASONIC AUTOMOTIVE SYSTEM;COMPANY OF AMERICA, 776 HWY 74 SOUTH, PEACHTREE CITY, GA, 30269, US

(73) Assignee: Panasonic Automotive Systems Company of America, Division of Panasonic Corporation of North America, Peachtree City, GA (US)

(21) Appl. No.: 12/231,807

(22) Filed: Sep. 5, 2008

(51) Int. Cl. A63F 13/00

(52) U.S. Cl. 463/31; 463/40

(57) ABSTRACT

A vehicle entertainment system is operable by a device remote from the entertainment system. The entertainment system includes an entertainment console including a plurality of entertainment applications. Each of the plurality of entertainment applications is adapted to receive and process an entertainment medium. The entertainment console includes an application program interface adapted to operate the plurality of entertainment applications and select an entertainment media. The entertainment console generates an output signal corresponding to the selected entertainment media. An output unit receives the output signal and generates an output corresponding to the selected entertainment medium. A wireless communication device is adapted to send and receive signals between the entertainment console and the remote device such that the application program interface is accessible using the remote device.

### BACKGROUND OF THE INVENTION

1. Field of the Invention

The present invention relates to vehicle entertainment systems and, more particularly, apparatuses and methods for controlling vehicle entertainment systems.

2. Description of the Related Art

Many vehicles include entertainment systems having components such as radios, DVD (digital video disc) players, CD (compact disc) players, cameras and navigational systems to provide entertainment and conveniences to the driver. These components are controlled using a user interface in the form of a control panel typically having many buttons, knobs, screens and other devices. The use of each of these components requires the user to understand how the control devices work with each application, which is often difficult to accomplish due to the control devices' complexity. Furthermore, some vehicles are equipped with entertainment systems capable of providing varying entertainment to different locations within the vehicle. For instance, those in the rear seats may watch a DVD, while those in the front seats may listen to the radio. Orchestrating these varying functions may also be confusing. In addition, these complexities are exacerbated when the user switches from one car to another car having a completely different control panel.

Accordingly, it would be beneficial if a user could operate a vehicle entertainment system using a remote device having an interface with which the user is familiar, and which the user may use for other purposes.

### SUMMARY

The present invention provides vehicle entertainment systems configured to allow operation by a device remote from the entertainment system, as well as methods for operating a vehicle entertainment system using a remote device.

In one aspect, the present invention provides a vehicle entertainment system operable by a wireless device disposed at a location that is remote from the entertainment system. The entertainment system includes an entertainment console including a plurality of entertainment applications. Each of the plurality of entertainment applications is adapted to receive and process an entertainment medium. The entertainment console includes an application program interface adapted to operate the plurality of entertainment applications and select an entertainment medium. The entertainment console generates an output signal corresponding to the selected entertainment medium. An output unit receives the output signal and generates an output corresponding to the selected entertainment medium. A wireless communication device is adapted to send and receive, or relay, wireless signals between the entertainment console and the remote device such that the application program interface is accessible by the remote device via said communication device.

In another aspect, a vehicle entertainment system is provided that includes an entertainment console including a plurality of entertainment applications adapted to receive and process an entertainment medium. The entertainment console includes an application program interface that is adapted to operate the plurality of entertainment applications and select an entertainment medium. The entertainment console generates an output signal corresponding to the selected entertainment medium. An output unit receives that output signal and generates an output corresponding to the selected entertainment medium. A wireless communication device is connected to the entertainment console and is adapted to send and receive signals between the entertainment console and the remote device. The wireless communication device includes a radio frequency communications module that is adapted to download at least a portion of the application program interface to the remote device.

In yet another aspect, a method for controlling the operation of a vehicle entertainment system is provided. This method includes the steps of equipping the vehicle entertainment system with a wireless communication device, the vehicle entertainment system having a plurality of entertainment applications and an application program interface for controlling the operation of the plurality of entertainment applications; downloading at least a portion of the application program interface from the vehicle entertainment system to a wireless remote device by use of the wireless communication device; and operating the plurality of entertainment applications using the downloaded application program interface and the remote device.

An advantage of the present invention is that a user may use a remote device, the controls of which the user is already familiar with, to control the entertainment system of the vehicle.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a diagram of a vehicle equipped with an entertainment system in accordance with one embodiment of the present invention;

FIG. 2 is a flow chart depicting the steps of controlling an entertainment system in accordance with one embodiment of the present invention;

FIG. 3 is a flow chart depicting the steps of controlling an entertainment system in accordance with another embodiment of the present invention; and

FIG. 4 is a flow chart depicting the steps of controlling operation of an entertainment system in accordance with yet another embodiment of the present invention.

Corresponding reference characters indicate corresponding parts throughout the several views. Although the drawings represent embodiments of the present invention, the drawings are not necessarily to scale and certain features may be exaggerated in order to better illustrate and explain the present invention. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

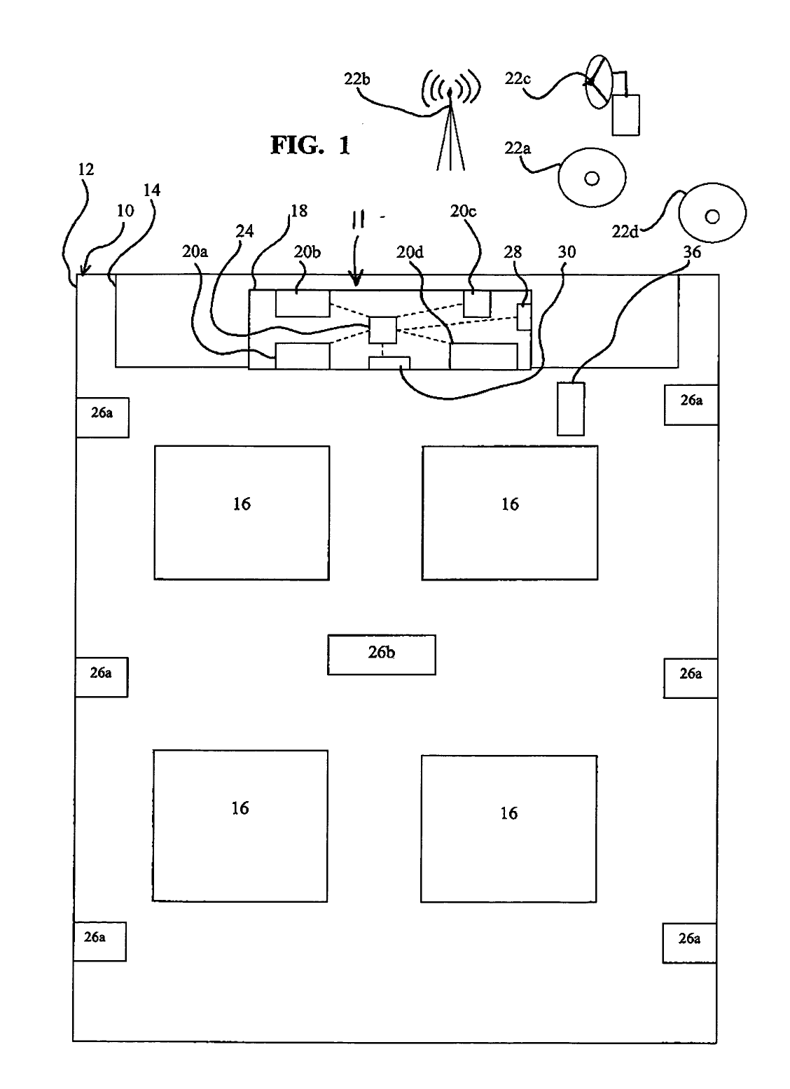

Referring to FIG. 1, vehicle 10 equipped with an entertainment system 11 in accordance with one embodiment of the present invention is illustrated. Vehicle 10 generally includes vehicle body 12 defining an interior space. Vehicle 10 includes dashboard 14 disposed within the interior space and extending along the front of vehicle body 12, and seats 16 disposed within the interior space. Entertainment system 11 generally includes entertainment console 18, output units 26a-26b communicatively coupled to entertainment console 18 and wireless communication device 28 communicatively coupled to entertainment console 18.

Referring still to FIG. 1, entertainment console 18 includes a plurality of entertainment applications 20a-20d adapted to receive and process entertainment media, such as entertainment media 22a-22d. Entertainment applications 20a-20d may include any application or device capable of receiving and processing entertainment media. For instance entertainment applications 20a-20d may include compact disc (CD) player 20a, broadcast radio receiver 20b, satellite radio receiver 20c and digital video disc (DVD) player 20d, which are adapted to respectively receive and process entertainment media such as CD 22a, broadcast radio signals/waves 22b, satellite radio signals 22c and DVD 22d, as depicted by the dashed lines. Alternatively, or additionally, entertainment applications may include other applications such as mP3 players, minidisk players, and navigational systems. Entertainment applications 20a-20d are adapted such that, upon receiving and processing entertainment media 22a-22d, entertainment console 18 generates an output signal corresponding to entertainment media 22a-22d.

Entertainment console 18 also includes application program interface 24, which is communicatively coupled to each of entertainment applications 20a-20d. Application program interface 24 is adapted to operate each of entertainment applications 20a-20d. Application program interface 24 may be in the form of, and include, any application program interface, processor, source code, object code, software, implementations or other programs useful in operating entertainment applications 20a-20d.

Entertainment console 18 also includes user interface 30, which communicatively coupled to application program interface 24. User interface 30 is adapted to receive commands from the user and allows the user to control the operation of application program interface 24 and, ultimately, entertainment applications 20a-20d. User interface 30 may be in any form suitable for allowing the user to operate application program interface 24. For instance, user interface 30 may include buttons, dials, scroll wheels, a keyboard, a touch pad, a voice recognition device, a mouse and/or other user interface devices.

Referring still to FIG. 1, output units 26a-26b are communicatively coupled to entertainment console 18 and are adapted to receive the output signal generated by entertainment console 18. Output units 26a-26b are configured to broadcast an output in the form that the user may recognize and enjoy. Output units 26a-26b may be any device capable of generating such an output. For instance, output units 26a-26b may include audio speakers 26a positioned throughout the interior space defined by vehicle body 12 and adapted to broadcast audio/sound through the interior space. Alternatively, or additionally, output units 26a-26b may include visual display unit 26b, such as a monitor or other video display unit, capable of displaying visual images.

Entertainment system 11 also includes wireless communication device 28, which is communicatively coupled and connected to entertainment console 18. Wireless communication device 28 is adapted to transmit information to a remote device 36 and receive information from remote device 36. Wireless communication device 28 may be any communication device capable of wirelessly communicating with a remote device. For instance, wireless communication device 28 may be in the form of a short range communications device such as a radio frequency communications module, a Wi-Fi communications module, IEEE 802.11 communications module, or a Bluetooth communications module. Remote device 36 may be in the form of any device capable of receiving and transmitting communications from wireless communication device 28. Remote device 36 may be in the form of a cellular phone, personal data assistance (PDA), iPhone, Blackberry®, laptop computer or other wireless communications device.

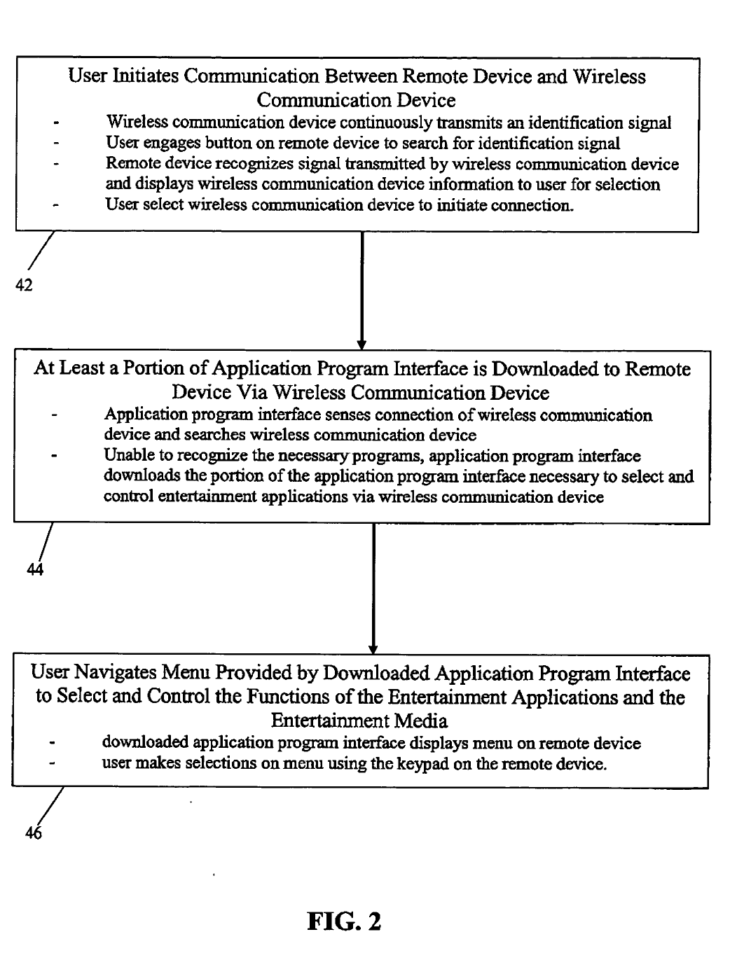

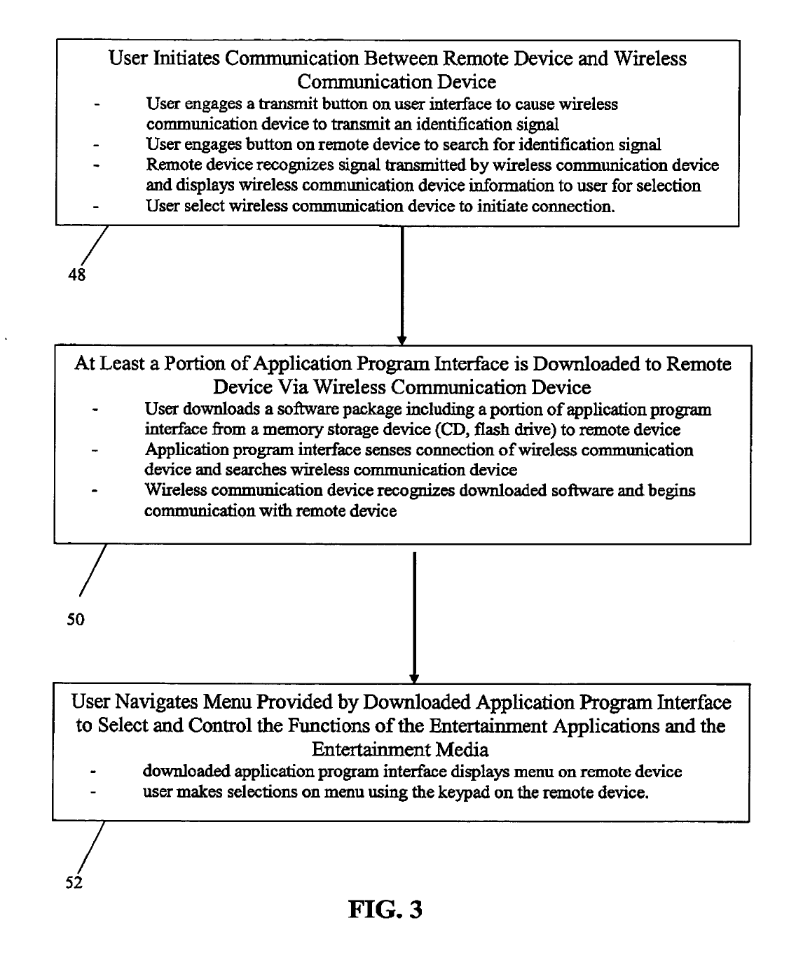

Referring now to FIGS. 2-3, operation of an entertainment system in accordance with one embodiment of the present invention will now be described. The entertainment system allows a user to operate and control the functions of the entertainment system using remote device 36 (FIG. 1). First, in step 42, the user initiates communication between remote device 36 and wireless communication device 28.

This may be accomplished by configuring wireless communication device 28 to generate a continuous wireless identification signal that may be recognized by remote device 36. Alternatively, user interface 30 may be equipped with a button that, when engaged, causes wireless communication device 28 to generate the identification signal. Accordingly, when the user is ready to connect to wireless communication device 28, the user may engage the button, thereby causing wireless communication device 28 to generate the signal. The user then causes remote device 36 to search for a wireless signal in the area. For instance, laptop computers typically have a network signal search button that the user engages to search for wireless networks, routers, hubs, modems or other wireless devices in the area. Remote device 36 recognizes the identification signal generated by wireless communication device 28, provides the user with the information identifying wireless communication device 28 and gives the user the option of connecting with wireless communication device 28. Remote device 36 may provide the option of connecting with wireless communication device 28 by providing a menu listing the available networks, modems and wireless signals in the area, including the wireless signal of wireless communication device 28, and allowing the user to select the wireless signal of the wireless communication device 28 using a touch pad, key pad, mouse or other user interface.

The above described connection method may be accomplished using radio frequency communications. However, it should be understood that communicative connection between console 18 and remote device 36 may be accomplished using other communication means including, for instance, a hard-wired connection. In addition, wireless communication device 28 need not be configured to continuously transmit an identification signal. Rather, console 18 can be configured such that user interface 30 includes a call button or transmit button that, upon engagement or actuation by the user, causes wireless communication device 28 to transmit a signal, such as an identification signal, recognizable by remote device 36 (step 48). Alternatively, wireless communication device 28 may be configured to receive calls from remote device 36, such that remote device 36 can transmit a call signal recognizable and answered by wireless communication device 28.

Once remote device 36 is connected to console 18 via wireless communication device 28, application program interface 24 senses the connection and, in response thereto, initiates a download of a portion of application program interface 24 to remote device 36 (step 44). More particularly, the portion (software) of application program interface 24 that allows the user to recognize and provide input to the operation of console 18 may be downloaded to remote device 36. This may be accomplished at the time remote device 36 is connected to console 18 via wireless communication device 28. In other words, once application program interface 24 recognizes that remote device 36 has connected, application program interface 24 searches for the needed portion of application program interface 24 on remote device 36. If remote device 36 lacks the needed portion of application program interface 24, application program interface 24 downloads that portion to remote device 36 via wireless communication device 28. Alternatively, the user may have that portion of application program interface 24 installed on remote device 36 other than via entertainment system 11. For instance, an external entity may provide the user with a downloadable software package stored on a memory storage device, such as a CD, memory stick, flash drive or other memory storage device. The software package may be downloaded to remote device 36 (step 50). The external entity that provides the downloadable software package may be the entertainment system provider, the manufacturer of the entertainment system (if different from the provider), the dealer from which the vehicle was purchased, or an after-market supplier, for example.

Once application program interface 24 is downloaded to remote device 36, remote device 36 displays to the user a menu and platform in which the user may make selections, provide inputs, and control the functions relating to the operation of entertainment applications 20a-20d (steps 46, 52). The user then controls the operation of entertainment applications 20a-20d using remote device 36, such as by actuation of a keypad on remote device 36.

In the below-described a practical example of how the system may be used, it is first assumed that entertainment console 18 of vehicle 10 allows the rear passengers to select and enjoy an entertainment application that is different from the front passengers. For instance, the rear passengers may watch a DVD on output unit 26b using entertainment application (DVD player) 20d and headphones (not shown) that connect to entertainment application 20d, while the front seat passengers listen to music using entertainment application (radio) 21b. However, the front passenger wishes to manage the tracks of the DVD and make selections for the rear passengers. Unfortunately, the front passenger is not familiar with the controls of console 18. The front passenger takes out his/her cell phone (remote device 36) and initiates connection with wireless communications device 28, as described above.

The cell phone recognizes and displays console 18 as a wireless device in the vicinity of the cell phone. The cell phone may display an icon or similar indication that console 18 is available for communication with the cell phone. The user then selects console 18 using the keypad and cell phone 36 connects with console 18 via wireless communications device 28. A portion of application program interface 24 is downloaded via wireless communication device 28 to cell phone 36. Cell phone 36 then displays a menu generated by the downloaded portion of application program interface 24. The first menu displayed may include a depiction of the vehicle and the varying zones of entertainment. For instance, the first menu may depict a vehicle having a first front zone and second rear zone. Using the keypad on cell phone 36, the user selects the second rear zone. A second menu may be related to the entertainment applications that are available to the rear zone. For instance, the second menu may include a selection button representing each of entertainment applications 21a-21d. The user may select the entertainment application to be enjoyed by the rear passengers. For example, the user may actuate or otherwise select the button pertaining to DVD player 20d.

After selecting the desired entertainment application, another menu is displayed on cell phone 36. This menu may display the menu, title or other coded information on the DVD that is currently in the DVD player. In addition, this menu may display a series of touch screen pushbuttons relating to the functions of the DVD player, such as a play button, pause button, fast forward button, next scene button, rewind button and menu button. This menu may also include a volume button. Using the keypad of the cell phone 36, the user selects the scene at which he/she would like the DVD to start, and selects the volume at which the audio tracks of the DVD will play. The menu may also be configured to select from which of speakers 26a the audio of the DVD should be broadcast. For example, the user may decide that the audio should be played through only the rear speakers. Alternatively, the user may decide that the audio should be played through only the headphones and, thus, all speakers 26a should be turned off.

The practical use described above is meant to be merely exemplary. The user may use the system in other ways for other purposes, such as selecting appropriate plays lists on mP3 or satellite radio entertainment applications. The user may use the system to program the tracks to be played from multiple CDs.

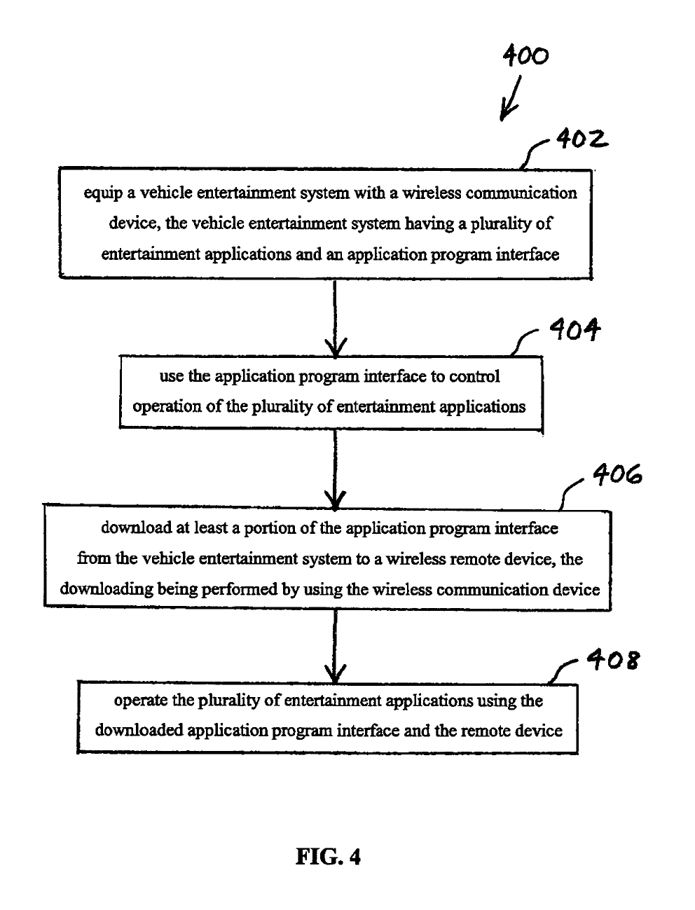

FIG. 4 illustrates another embodiment of a method 400 of the present invention for controlling operation of a vehicle entertainment system. In a first step 402, the vehicle entertainment system is equipped with a wireless communication device, the vehicle entertainment system having a plurality of entertainment applications and an application program interface. For example, vehicle entertainment system 11 may be equipped with a wireless communication device 28, and vehicle entertainment system 11 may have a plurality of entertainment applications 20a-20d and an application program interface 24.

In a next step 404, the application program interface is used to control operation of the plurality of entertainment applications. That is, application program interface 24 may be used to control operation of entertainment applications 20a-20d.

Next, in step 406, at least a portion of the application program interface is downloaded from the vehicle entertainment system to a wireless remote device, the downloading being performed by using the wireless communication device. For example, the portion of application program interface 24 that allows the user to recognize and provide input to the operation of console 18 may be downloaded from vehicle entertainment system 11 to wireless remote device 36. The downloading may be performed by use of wireless communication device 28.

In a final step 408, the plurality of entertainment applications are operated using the downloaded application program interface and the remote device. For example, entertainment applications 20a-20d may be operated using the downloaded portion of application program interface 24 and remote device 36.

The present invention has been described herein as being used to control an entertainment system. However, it is to be understood that the present invention is equally applicable to controlling information systems, such as navigation systems.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A vehicle entertainment system, comprising:
an entertainment console including a plurality of entertainment applications, said plurality of entertainment applications adapted to receive and process an entertainment medium, said entertainment console including an application program interface, said application program interface adapted to operate said plurality of entertainment applications and select an entertainment medium, said entertainment console generating an output signal corresponding to said selected entertainment medium;
an output unit receiving said output signal and generating an output corresponding to said selected entertainment medium; and
a wireless communication device connected to said entertainment console and adapted to relay wireless signals between said entertainment console and a wireless remote device disposed at a location that is remote from the entertainment system such that said application program interface is accessible by the remote device via said communication device.

2. The entertainment system of claim 1 wherein said wireless communication device is adapted to download at least a portion of said application program interface into the remote device.

3. The entertainment system of claim 1 wherein said wireless communication device is a radio frequency communications module.

4. The entertainment system of claim 3 wherein said communications module is a Bluetooth module.

5. The entertainment system of claim 3 wherein said communications module is a Wi-Fi module.

6. The entertainment system of claim 1 wherein said plurality of entertainment applications includes a radio.

7. The entertainment system of claim 1 wherein said plurality of entertainment applications includes an mP3 player.

8. The entertainment system of claim 1 wherein said output unit includes at least one speaker.

9. The entertainment system of claim 1 wherein said output unit includes a video display unit.

10. A vehicle entertainment system, comprising:
an entertainment console including a plurality of entertainment applications, said plurality of entertainment applications adapted to receive and process an entertainment medium, said entertainment console including an application program interface, said application program interface adapted to operate said plurality of entertainment applications and select an entertainment medium, said entertainment console generating an output signal corresponding to said selected entertainment medium;
an output unit receiving said output signal and generating an output corresponding to said selected entertainment medium; and
a wireless communication device adapted to send and receive signals between said entertainment console and a wireless remote device that is disposed at a location that is remote from the entertainment system, said wireless communication device including a radio frequency communications module, said radio frequency communications module adapted to download at least a portion of said application program interface to the remote device.

11. The entertainment system of claim 10 wherein said communications module is a Bluetooth module.

12. The entertainment system of claim 10 wherein said communications module is a Wi-Fi module.

13. The entertainment system of claim 10 wherein said plurality of entertainment applications includes a radio.

14. The entertainment system of claim 10 wherein said plurality of entertainment applications includes a music storage device player.

15. The entertainment system of claim 10 wherein said output unit includes a plurality of speakers.

16. The entertainment system of claim 10 wherein said output unit includes a video display unit.

17. A method for controlling operation of a vehicle entertainment system comprising the steps of:
equipping the vehicle entertainment system with a wireless communication device, the vehicle entertainment system having a plurality of entertainment applications and an application program interface;
using the application program interface to control operation of the plurality of entertainment applications;
downloading at least a portion of the application program interface from the vehicle entertainment system to a wireless remote device, the downloading being performed by using the wireless communication device; and
operating the plurality of entertainment applications using the downloaded application program interface and the remote device.

18. The method of claim 17 wherein the remote device is a cellular phone, the operating step including actuating a user interface of the cellular phone.

19. The method of claim 17 wherein the wireless communication device includes a Wi-Fi communication module.

20. The method of claim 17 wherein the wireless communication device includes a radio frequency communication module.
